(19) United States
(12) Patent Application Publication
(10) Pub. No.: US 2011/0096098 A1
(43) Pub. Date: Apr. 28, 2011

(54) LOW LUMINANCE READABILITY IMPROVEMENT SYSTEM AND METHOD FOR LIQUID CRYSTAL DISPLAYS

(75) Inventors: Victoria Haim, Glendale, AZ (US); Elias S. Haim, Glendale, AZ (US); Brent D. Larson, Cave Creek, AZ (US); Dennis Davey, Phoenix, AZ (US)

(73) Assignee: HONEYWELL INTERNATIONAL INC., Morristown, NJ (US)

(21) Appl. No.: 12/605,942

(22) Filed: Oct. 26, 2009

(51) Int. Cl. G09G 5/10

(52) U.S. Cl. 345/690

(57) ABSTRACT

A display system and method is provided to increase the ability to recognize and distinguish red, magenta, and various other colors rendered on a display device by dynamically compensating for, at least in part, changes in the human vision system when the display luminance is within the mesopic range. The dynamic compensation enables the display system to be optimized differently depending upon the visual luminance range, be it photopic, mesopic, or scotopic.

### TECHNICAL FIELD

The present invention generally relates to displays, and more particularly relates to systems and methods for improving the readability of one or more colors rendered on a display under low luminance conditions.

### BACKGROUND

As is generally known, the sensitivity of the human vision system varies with the ambient luminance level. This is due to the physiology of the human vision system, which comprises what are known as rod receptors and cone receptors. Generally speaking, during relatively high ambient luminance levels (e.g., typical daylight conditions) cone receptors are the dominant receptors, and the human vision system exhibits what is generally referred to as photopic vision. Photopic vision is characterized by relatively high visual acuity and color vision. During very low ambient luminance levels (e.g., very dark nighttime conditions) rod receptors are the dominant receptors, and the human vision system exhibits what is generally referred to as scotopic vision. Scotopic vision is characterized by low visual acuity, high temporal sensitivity, and achromatic vision. At ambient luminance levels between photopic and scotopic conditions, rod receptors and cone receptors are both active, and the human vision system exhibits what is generally referred to as mesopic vision. Mesopic vision is characterized by degraded color vision and resolution and a shift in spectral sensitivity to shorter wavelengths.

The brightness of a display, such as a liquid crystal display (LCD), may be varied depending upon the ambient luminance level. For example, during relatively low ambient luminance levels, such as during long nighttime aircraft flights, the brightness of a display is typically set to the minimum level for readability of any white symbology that may be displayed. In many instances the ambient luminance level during nighttime aircraft flights enable pilots to remain sufficiently dark adapted to allow simultaneous monitoring of the aircraft systems on various displays and viewing of the surroundings outside the cabin. The resultant luminance levels are often in the mesopic range of the human vision system. As a result, the ability of a pilot to distinguish colored symbology rendered on a display diminishes. For example, certain red and/or magenta symbologies, which are typically used to indicate relatively high importance information, can be difficult to read.

Hence, what is needed is a system and method of improving the visibility of one or more colors relative to white under mesopic conditions, to thereby improve the readability of the one or more colors. The present invention addresses at least this need.

### BRIEF SUMMARY

In one exemplary embodiment, a method of improving low luminance readability of a display device includes determining when mesopic conditions exist. When mesopic conditions are determined to exist, the spectral ratios of chromatic constituents are selectively modified to provide enhanced visibility and discrimination of one or more colors. The one or more colors are then rendered on the display device.

In another embodiment, display system for improving low luminance readability of a display device includes the display device and a processor. The display device is coupled to receive chromatic control signals and is configured, in response thereto, to render one or more colors thereon. The processor is adapted to receive at least chromatic control signals and a mesopic parameter signal. The processor is configured, upon receipt of the chromatic control signals and the mesopic parameter signal, to determine when mesopic conditions exist. If it is determined that mesopic conditions do not exist, the processor is configured to supply the chromatic control signals without modification to the display device. If it is determined that mesopic conditions do exist, the processor is configured to modify the spectral ratios of the chromatic constituents represented by the chromatic control signals to provide enhanced visibility and discrimination of the one or more colors rendered on the display device.

Other desirable features and characteristics of the display system and method will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a functional block diagram of at least a portion of an exemplary display system;

FIG. 2 depicts an exemplary process, in flowchart form, that may be implemented by the system of FIG. 1;

FIG. 3 graphically depicts the exemplary process of FIG. 2;

FIG. 4 depicts another exemplary process, in flowchart form, that may be implemented by the system of FIG. 1;

FIG. 5 graphically depicts variations of the exemplary process of FIG. 2; and

FIG. 6 is a functional block diagram of at least a portion of another exemplary display system.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The present invention increases the ability to recognize and distinguish red, magenta, and various other colors rendered on a display by dynamically compensating for, at least in part, changes in the human vision system when the display luminance is within the mesopic range. Several embodiments are described herein to achieve this, each relating to dynamic changes in the luminance ratios or chrominance ratios of colors as measured or calculated using standardized photopic weightings. In this way, the impact of luminance-related shifts in visual spectral sensitivity can be minimized. The dynamic compensation disclosed herein enables the display system to be optimized differently depending upon the visual luminance range. For example, photopic performance at high ambient conditions allows optimization based on metrics such as image quality or power efficiency, while mesopic performance can be optimized for distinguishment of colors, of which red is one example.

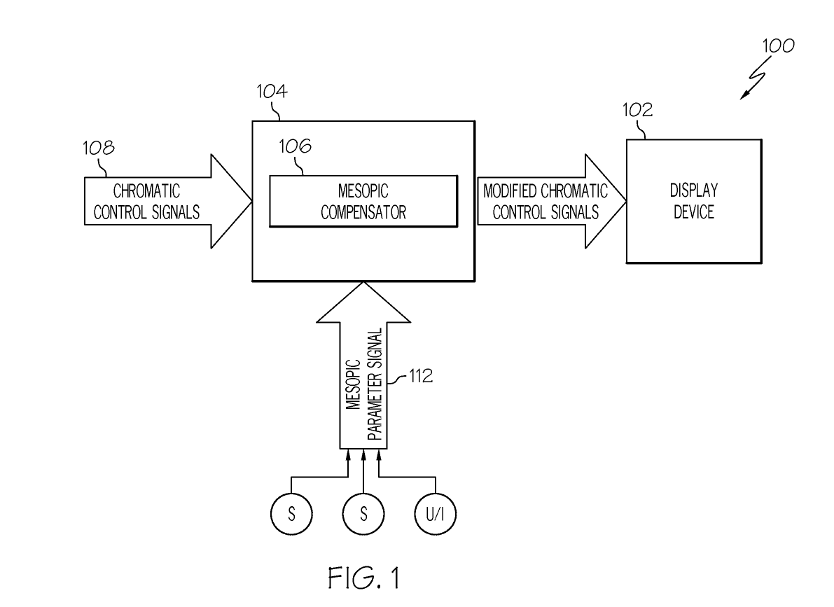

A functional block diagram of at least a portion of an exemplary display system 100 is depicted in FIG. 1, and includes a display device 102 and a processor 104. The display device 102 is used to display various images and data, in a graphic, iconic, and a textual format, and to supply visual feedback to a user. It will be appreciated that the display device 102 may be implemented using any one of numerous known displays suitable for rendering graphic, iconic, and/or text data in a format viewable by a user. Non-limiting examples of such displays include various cathode ray tube (CRT) displays, and various flat panel displays, such as various types of LCD (liquid crystal display), TFT (thin film transistor), and OLED (organic light emitting diode) displays. The display may additionally be based on a panel mounted display, a HUD projection, or any known technology. In an exemplary embodiment, display device 102 includes a panel display. It is further noted that the system 100 could be implemented with more than one display device 102. For example, the system 100 could be implemented with two or more display devices 102.

No matter the number or particular type of display that is used to implement the display device 102, the processor 104 is responsive to the various data it receives to render various images on the display device 102. The images that the processor 102 renders on the display device 102 will depend, for example, on the type of display being implemented. For example, in the context of an aircraft cockpit display system, the display device 104 may implement one or more of a multi-function display (MFD), a primary flight display (PFD), a synthetic vision system (SVS) display, a vertical situation display (VSD), and a horizontal situation indicator (HSI), just to name a few. Moreover, the system 100 may be implemented with multiple display devices 102, each of which may implement one or more of these different, non-limiting displays.

The processor 104 is in operable communication with the display device 102. The processor 104 is coupled to receive various signals from various non-illustrated sources. The processor 104 is configured, in response to these signals, to command various images to be rendered on the display device 102. The processor 104 may be any one (or a plurality) of numerous known general-purpose microprocessors or application specific processor(s) that operates in response to program instructions. It will be appreciated that the processor 104 may be implemented using various other circuits, not just a programmable processor. For example, digital logic circuits and analog signal processing circuits could also be used. In this respect, the processor 104 may include or cooperate with any number of software programs (e.g., avionics display programs) or instructions designed to carry out various methods, process tasks, calculations, and control/display functions, at least one of which is described below.

The processor 104, as just noted, may implement various control/display functions. Included among these functions, at least in the depicted embodiment, is what is referred to herein as a mesopic compensator 106. The mesopic compensator 106 is supplied with at least chromatic control signals 108 and a mesopic parameter signal 112 and, in response to these signals, supplies either unmodified or modified chromatic control signals 108 to the display device 102. As will be described in more detail further below, the modified chromatic control signals 108 cause the display device 102 to render various images in a manner that provides enhanced visibility and/or discrimination of selected chromatic content during mesopic conditions. For example, content displayed as red and/or magenta (or any one or more of numerous other colors) may be rendered in a manner that provides enhanced visibility and/or discrimination.

The chromatic control signals 108 that are supplied to the mesopic compensator 106 are representative of various signals used to render various chromatic content under photopic conditions. The chromatic control signals 108 may be supplied in any one or more of numerous forms, and represent any one of numerous means for describing color on a display. For example, these signals may be supplied as RGB graylevels, Lxy, Lu′v′, backlight drive ratios, pixel drive voltages and/or currents, or LCD column voltages, just to name a few.

The mesopic parameter signal 112 is a signal representative of the display luminance level operating point in the mesopic range. The mesopic parameter signal 112 may be supplied to the mesopic compensator 106 from various sources, and may be in any one of numerous forms (e.g., analog or digital). Some non-limiting examples of suitable sources include an ambient light sensor, a commanded drive luminance or brightness, a backlight sensor, a commanded backlight level, or a user input, just to name a few. No matter the specific source or form of the mesopic parameter signal 112, the mesopic compensator 106 uses the mesopic parameter signal 112 to determine if mesopic conditions exist. It will be appreciated that the manner and display luminance level at which the mesopic compensator 106 determines that mesopic conditions exist may vary. For example, the mesopic compensator 106 may determine the display luminance level from the mesopic parameter signal 112 and compare it to a predetermined, stored value that is established to represent mesopic conditions. Alternatively, the determined display luminance level may be compared to a user-supplied value that individual users may input to establish when mesopic conditions exist for that individual. It will additionally be appreciated that these are merely exemplary of any one of numerous ways in which the mesopic compensator 106 may be configured to determine the existence of mesopic conditions. In addition to determining when mesopic conditions exist, the mesopic compensator 106 may also use the mesopic parameter signal 112, at least in some embodiments, to determine where the operating point is within the mesopic range.

Before proceeding further it should be noted that a standardized method for characterizing the mesopic range does not presently exist. However, a generally accepted approximation of the mesopic range, using the standard luminance unit cd/m² based on photopic spectral weighting, is about 0.001 cd/m² to 10 cd/m². Hence, with this approximation luminance levels above 10 cd/m² would be in photopic range, while luminance levels below 0.001 cd/m² would be in the scotopic range. Nonetheless, it will be appreciated that this is merely exemplary of one generally accepted range, and that various other acceptable ranges may be used.

No matter the specific limits that are used to define the mesopic range or the manner in which the mesopic compensator 106 determines when mesopic conditions exist, if the determination is made that mesopic conditions do not exist, then the mesopic compensator 106 does not modify the chromatic control signals 108. If, however, it is determined that mesopic conditions do exist, the mesopic compensator 106 does modify the chromatic control signals 108. More specifically, the mesopic compensator 106 selectively modifies constituent spectral ratios represented by the chromatic control signals 108 to provide the enhanced visibility and discrimination of certain colors under mesopic conditions. As with the chromatic control signals 108 supplied to the mesopic compensator 106, the modified chromatic control signals 108 may be supplied to the display device 102 in any one or more of numerous forms, and represent any one of numerous means for describing color on a display. Again, some non-limiting examples include, but are not limited to RGB graylevels, Lxy, Lu′v′, backlight drive ratios, pixel drive voltages and/or currents, or LCD column voltages, just to name a few.

The specific means by which the mesopic compensator 106 selectively implements the modifications to the constituent spectral ratios may also vary. For example, the mesopic compensator 106 may use one or more look-up tables, one or more mapping functions, various software algorithms, electronic drive circuitry, backlight drive modification, backlight source selection, symbology generation software, or variable reference signals, just to name a few non-limiting examples. In addition to the various means by which the mesopic compensator 106 selectively implements the modifications to the constituent spectral ratios, there are also various spectral ratio modification processes that the mesopic compensator may implement. Some non-limiting examples of the various spectral ratio modification processes will now be described.

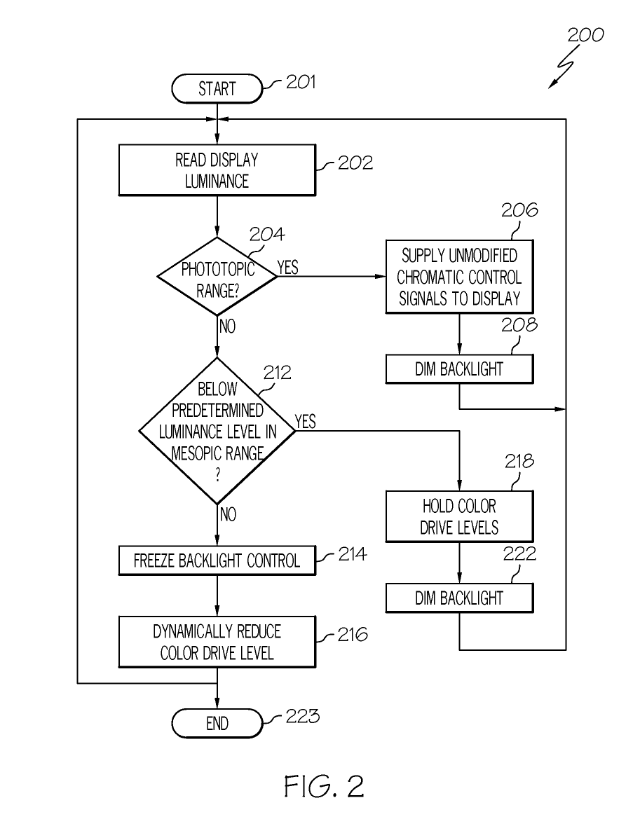

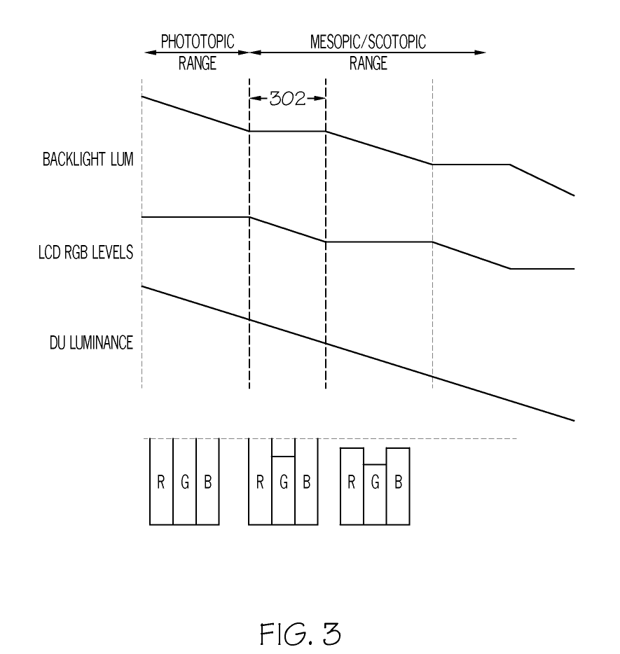

In accordance with one exemplary process, the mesopic compensator 106 selectively reduces the effective drive level or luminance of certain symbol colors relative to other colors. An example of this process 200 is depicted in flowchart form in FIG. 2 and in graphical form in FIG. 3, and with reference to both of these figures will now be described. Initially, it is seen that the display luminance is read and determined (202). As described above, the mesopic compensator 106, at least in the depicted embodiment, implements this part of the process using the mesopic parameter signal 112. A determination is then made as to whether the display luminance is in the photopic range (204). If so, then unmodified chromatic control signals 108 are supplied to the display device 102 (206). However, as FIG. 3 more clearly illustrates, the display luminance is controlled in the photopic range via the display backlight (208).

If the display luminance is determined to not be in the photopic range, then a determination is made as to whether the display luminance is in the mesopic range (212). If so, then the display backlight control is frozen (214). That is, as is shown more clearly in FIG. 3, the backlight luminance level at the boundary of the photopic and mesopic ranges is held through at least a portion of the mesopic range 302 (referred to herein as a “chromatic modification range”). In addition, the display luminance is controlled by decreasing the drive level of one or more colors (216). In the exemplary embodiment depicted in FIG. 3, it is seen that the green drive level is dynamically decreased, whereas the red and blue drive levels remain constant through the chromatic modification range 302. Hence, the red and blue luminance levels increase as a percentage of white. Before proceeding further, it will be appreciated that the manner in which the green (or other chromatic constituent) drive level is adjusted within the mesopic range may vary. For example, it may be linearly or non-linearly adjusted to meet desired results. It will additionally be appreciated that color drive level that is dynamically adjusted may vary to meet desired results. It need not be just green, nor need it be a single color drive level. Moreover, although the chromatic constituent drive level variation is preferably done gradually over at least a portion of the mesopic range (e.g., a chromatic modification range), it could also be done at one or more discrete luminance points in the mesopic range.

Returning once again to the process 200, if the luminance is below a predetermined luminance level in the mesopic range (e.g., below the chromatic modification range), which in some embodiments may include the scotopic range, then the unequal color drive levels that were in place at that time are held constant (218). However, the display luminance is once again controlled via the display backlight (222). It will be appreciated that although only a single chromatic modification range 302, where the display backlight level is held constant and the display output is controlled by varying the relative color drive levels, is depicted in FIG. 3, a plurality of chromatic modification ranges may be implemented whereby this pattern is repeated as many times as may be deemed necessary, though only a single recurrence is depicted in FIG. 3.

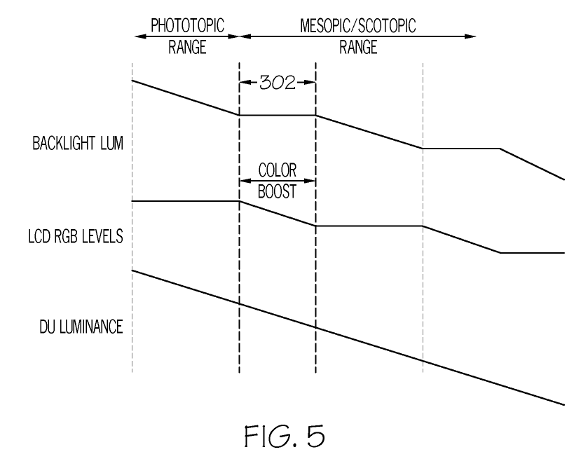

Although the backlight luminance is held constant through the chromatic modification range 302 in the above-described process, it will be appreciated that this is merely exemplary and that the backlight luminance could be varied through the chromatic modification range 302, at either the same or different rate as in the photopic range. An example of this particular variation of the process 200 depicted in FIG. 2 and described above is illustrated in FIG. 5, and is believed self-explanatory. In addition to the example depicted in FIG. 5, in which the backlight luminance is varied through the entirety of the chromatic modification range(s), in other embodiments the backlight luminance could be varied through one or more portions of the chromatic modification range(s).

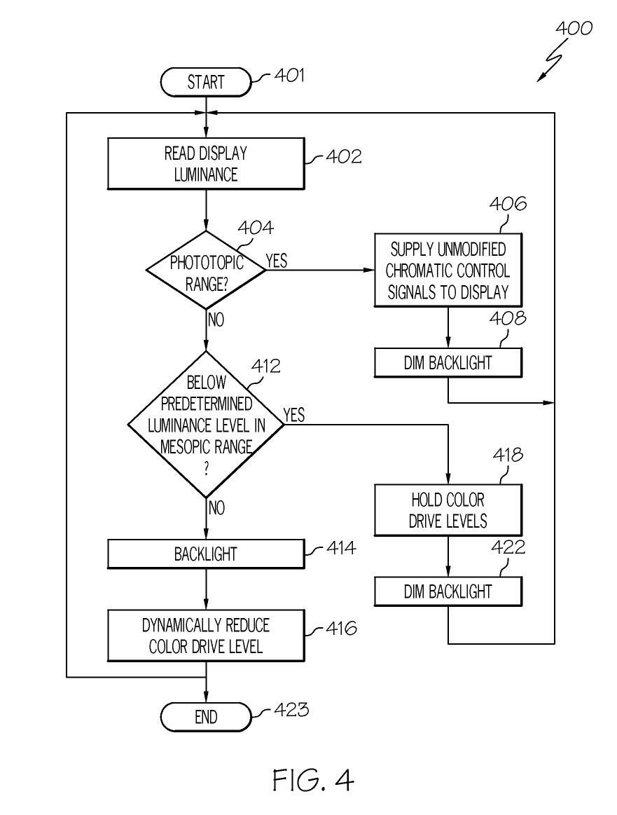

In accordance with another exemplary process, the mesopic compensator 106 adjusts the photopically weighted luminance ratios by desaturating certain colors in the mesopic range. One example of this general process would be the addition of small amounts of green and blue to red symbols to increase the ratio of red luminance to white luminance as overall luminance is decreased. An example of this process 400 is depicted in flowchart form in FIG. 4, and will now be described.

Initially, it is seen that the display luminance is read and determined (402). As described above, the mesopic compensator 106, at least in the depicted embodiment, implements this part of the process using the mesopic parameter signal 112. A determination is then made as to whether the display luminance is in the photopic range (404). If so, then unmodified chromatic control signals 108 are supplied to the display device 102 (406). However, as before, the display luminance is controlled in the photopic range via the display backlight (408).

If the display luminance is determined to not be in the photopic range, then a determination is made as to whether the display luminance is in the mesopic range (412). If so, then the display backlight continues to be dimmed (414). In addition, the display luminance is controlled by desaturating the luminance level of one or more colors (416) through at least a portion of the mesopic range (e.g., a chromatic modification range). For example, pure red color pixels may be desaturated by increasing the blue and/or green drive levels for these pixels. This effectively boosts the luminance of red relative to white for the same backlight luminance.

To provide a specific example, assume an RGB pixel is being driven, using an 8-bit driver, as pure red. In such an instance, the corresponding drive levels for R, G, and B pixel elements would be 255, 0, and 0, respectively. In the mesopic range, however, the pure red would be desaturated by keeping the drive level for the R pixel element at 255, but increasing the G and B pixel element drive levels. The specific drive levels may vary, and may be equal or unequal. Moreover, the drive level adjustments through the mesopic range may be linear or non-linear to meet desired results. It will additionally be appreciated that color drive level that is desaturated may vary to meet desired results. It need not be red, nor need it be a single color. Moreover, the desaturation is preferably done gradually over at least a portion of the mesopic range (e.g., a chromatic modification range), but could also be done at one or more discrete luminance points in the mesopic range.

Returning once again to the process 400, if the luminance is below a predetermined luminance level in the mesopic range, which in some embodiments may include the scotopic range, then the desaturating color drive levels that were in place at that time are held constant (418). However, the display luminance is once again controlled via the display backlight (422). It will be appreciated that, as with the previously described embodiment, this pattern may be repeated for as many times as may be deemed necessary.

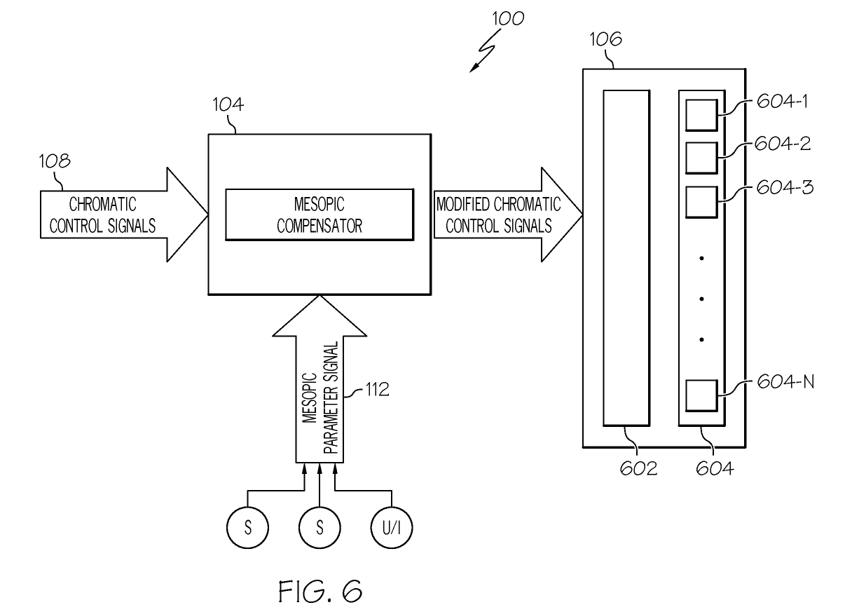

In yet another exemplary process, one or more constituent colors may be overdriven when in the mesopic range, such as in the case of an emissive display. In still another exemplary process, rather than selectively control display colors, the spectral output of the backlight of a backlit display is adjusted as a function of the display luminance or drive level in the mesopic range. The dynamic spectral adjustment of a backlight can be achieved by adjusting the relative mix of multiple source types (e.g. white LEDs plus red LEDs) or via controllable variability of a single source type as a function of luminance. In one particular exemplary embodiment, which is depicted in FIG. 6, the display 102 includes a primary light source 602 and one or more supplemental light sources 604. The primary light source 602 is controlled to remain active throughout the photopic and mesopic ranges, while the supplemental light source 604 is controlled to be active through at least portions of the mesopic range (e.g., one or more chromatic modification ranges). The relative mix of output levels for the primary and supplemental light sources 602, 604 is varied to achieve chromatic modification over the one or more chromatic modification ranges. In one exemplary embodiment, the primary light source 602 comprises white LEDs and the supplemental light source 604 comprises red LEDs. In another embodiment, the variation of the relative mix of output levels results in display output colors having more saturated red chromaticities in the mesopic range than in the photopic range. In yet another exemplary embodiment, the display device 104 may include multiple supplemental light sources (e.g., 604-1, 604-2, 604-3, . . . 604-N). In this embodiment, all of the supplemental light sources 604 are controlled to be active through at least portions of the mesopic range.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method of improving low luminance readability of a display device, the method comprising the steps of:
determining when mesopic conditions exist;
when mesopic conditions are determined to exist, selectively modifying spectral ratios of chromatic constituents to provide enhanced visibility and discrimination of one or more colors; and
rendering the one or more colors on the display device.

2. The method of claim 1, wherein the step of selectively modifying spectral ratios of chromatic constituents comprises selectively reducing effective luminance of one or more chromatic constituents relative to one or more other chromatic constituents.

3. The method of claim 2, further comprising:
selectively reducing the effective luminance of one or more chromatic constituents linearly as a function of display luminance.

4. The method of claim 2, further comprising:
selectively reducing the effective luminance of one or more chromatic constituents non-linearly as a function of display luminance.

5. The method of claim 1, wherein the step of selectively modifying spectral ratios of chromatic constituents comprises selectively desaturating a chromatic constituent.

6. The method of claim 5, wherein the step of selectively desaturating a chromatic constituent comprises increasing a chromatic constituent.

7. The method of claim 1, wherein the step of determining when mesopic conditions exist comprises:
sensing ambient light; and
processing the sensed ambient light.

8. The method of claim 1, wherein the step of determining when mesopic conditions exist comprises:
sensing backlight luminance; and
processing the sensed backlight luminance.

9. The method of claim 1, wherein the step of determining when mesopic conditions exist comprises receiving and processing a commanded luminance signal.

10. The method of claim 1, wherein the step of determining when mesopic conditions exist comprises receiving and processing a user input signal.

11. The method of claim 1, wherein the step of selectively modifying spectral ratios of chromatic constituents comprises selectively controlling a plurality of backlight light sources.

12. A display system for improving low luminance readability of a display device, comprising:
a display device coupled to receive chromatic control signals and configured, in response thereto, to render one or more colors thereon; and
a processor adapted to receive at least chromatic control signals and a mesopic parameter signal, the processor configured, upon receipt of the chromatic control signals and the mesopic parameter signal, to determine when mesopic conditions exist and:
(i) supply the chromatic control signals without modification to the display device if it is determined that mesopic conditions do not exist, and
(ii) modify spectral ratios of chromatic constituents represented by the chromatic control signals if it is determined that mesopic conditions do exist to provide enhanced visibility and discrimination of the one or more colors rendered on the display device.

13. The system of claim 12, wherein the processor is configured to modify the spectral ratios of the chromatic constituents by selectively reducing effective luminance of one or more chromatic constituents relative to one or more other chromatic constituents.

14. The system of claim 13, wherein the processor is configured to selectively reduce the effective luminance of one or more chromatic constituents linearly as a function of display luminance.

15. The system of claim 13, wherein the processor is configured to selectively reduce the effective luminance of one or more chromatic constituents non-linearly as a function of display luminance.

16. The system of claim 12, wherein the processor is configured to modify the spectral ratios of the chromatic constituents by selectively desaturating a chromatic constituent.

17. The system of claim 16, wherein the processor is configured to selectively desaturate the chromatic constituent by increasing a chromatic constituent.

18. The system of claim 12, further comprising:
a light sensor coupled to the processor and configured to sense light and supply the mesopic parameter signal to the processor based on the sensed ambient light.

19. The system of claim 12, wherein the light sensor is configured to sense one or more of ambient light and backlight luminance.

20. The system of claim 11, wherein the mesopic parameter signal comprises a command signal representative of a commanded luminance.

21. The system of claim 20, further comprising:
a user interface coupled to the processor and adapted to receive input from a user, the user interface responsive to the input from a user to supply the command signal.
